(19) United States
(12) Patent Application Publication
(10) Pub. No.: US 2006/0196345 A1
(43) Pub. Date: Sep. 7, 2006

(54) Music player

(75) Inventor: Yoshihisa Arai, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/358,223

(22) Filed: Feb. 22, 2006

(30) Foreign Application Priority Data
Feb. 23, 2005 (JP) 2005-47946

(51) Int. Cl. G10H 7/00

(52) U.S. Cl. 84/604

(57) ABSTRACT

A music player comprising a driving mechanism configured to rotate a storage medium, and to read a music file out of the storage medium. A nonvolatile memory is configured to store the music file transferred from the storage medium. A processor is configured to read out the music file out of the nonvolatile memory, and to play the music file.

### CROSS REFERENCE TO RELATED APPLICATION AND INCORPORATION BY REFERENCE

This application is based upon and claims the benefit of priority from prior Japanese Patent Application P2005-47946 filed on Feb. 23, 2005; the entire contents of which are incorporated by reference herein.

### BACKGROUND OF THE INVENTION

1. Field of the Invention

The present invention relates to a music player of portable type driven by a battery.

2. Description of the Related Art

Along with the popularization of compression techniques for music files (music data), developments of portable music players having large-capacity storage media are now in progress. When a memory card or an embedded nonvolatile memory is used as a storage medium, a mechanical driving mechanism (hereinafter simply referred to as a “driving mechanism”) including a small actuator is not required. Accordingly, in a music player applying either a memory card or an embedded nonvolatile memory as a storage medium, reduction in power consumption has been attempted by use of a digital signal processing. In recent years, music players embedding hard disks have been coming out to the market to meet demands for carrying more music pieces.

However, when the hard disk is used as the storage medium, the driving mechanism of the hard disk consumes an extremely large amount of electric currents. Therefore, operable time of the music player driven by a battery is shortened. Moreover, the driving mechanism of the hard disk is vulnerable to vibration and impact. Accordingly, it is desirable to suspend the driving mechanism as much as possible to prevent the music player from failures.

### SUMMARY OF THE INVENTION

An aspect of the present invention inheres in a music player encompassing, a driving mechanism configured to rotate a storage medium, and to read a music file out of the storage medium, a nonvolatile memory configured to store the music file transferred from the storage medium, and a processor configured to read out the music file out of the nonvolatile memory, and to play the music file.

Another aspect of the present invention inheres in a music player configured to play a music file read out of a removable storage medium, having a storage medium and a driving mechanism configured to rotate the storage medium, comprising, a connector configured to connect the removable storage medium, a nonvolatile memory configured to store the music file read out of the storage medium, and a processor configured to read the music file out of the nonvolatile memory, and to play the music file.

### BRIEF DESCRIPTION OF THE DRAWINGS

FIG. 1 is a block diagram showing a music player according to a first embodiment of the present invention.

FIG. 2 is a flow chart showing an operation of the music player according to the first embodiment.

FIG. 3 is a flow chart showing an operation of the music player according to a first modification of the first embodiment.

FIG. 4 is a block diagram showing a music player according to a second modification of the first embodiment.

FIG. 5 is a schematic diagram showing a data arrangement in a nonvolatile memory according to a second embodiment of the present invention.

FIG. 6 is a flow chart showing an operation of a music player according to the second embodiment.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and description of the same or similar parts and elements will be omitted or simplified. In the following descriptions, numerous specific details are set forth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention with unnecessary detail. In the following description, the words “connect” or “connected” defines a state in which first and second elements are electrically connected to each other without regard to whether or not there is a physical connection between the elements.

### First Embodiment

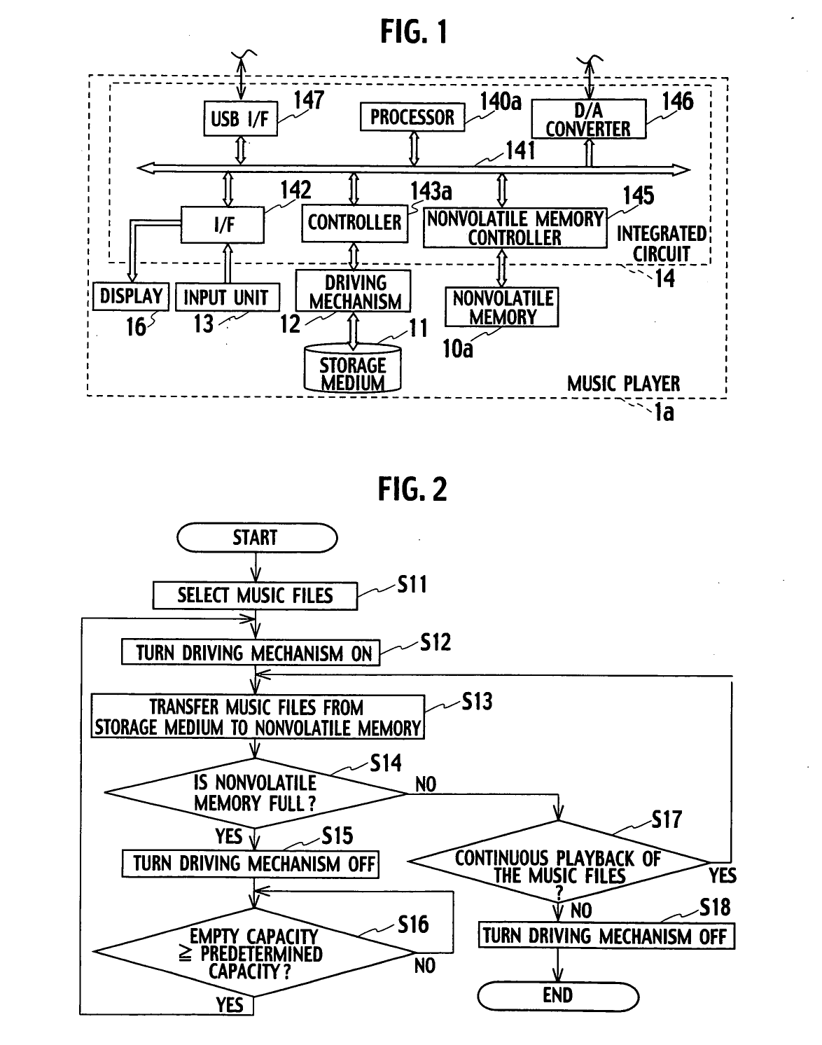

As shown in FIG. 1, a music player 1a according to a first embodiment of the present invention includes a nonvolatile memory 10a, a storage medium 11, a driving mechanism 12, an input unit 13, an integrated circuit 14, and a display 16. The integrated circuit 14 includes a processor 140a, a bus line 141, an interface (I/F) 142, a controller 143a, a nonvolatile memory controller 145, a digital-analog (D/A) converter 146, and a universal serial bus interface (USB I/F) 147.

The driving mechanism 12 rotates the storage medium 11 and reads a music file out of the storage medium 11. The music file from the storage medium 11 is stored in the nonvolatile memory 10a. The processor 140a reads the music file out of the nonvolatile memory 10a and plays the music file. The processor 140a reads the music file out of the nonvolatile memory 10a in a predetermined period after turning the power on without operating the driving mechanism 12.

Here, the “power-on” refers to a state of resuming an operation of a music player 1a, or a state of recovery from a standby state after a playback is interrupted. The music player 1a is set to the standby state when the power is turned off in the middle of a playback, and restarts the playback from the interrupted point when the power is turned on again. Therefore, the processor 140a is operated in the power-on state on the premise that there is the music file in the nonvolatile memory 10a. On the contrary, in a start-up mode from an initial state (a reset state), no music file is stored in the nonvolatile memory 10a. Accordingly, the processor 140a operates the driving mechanism 12.

A disk-shaped storage medium can be utilized as the storage medium 11. Here, the “disk-shaped storage medium” refers to a magnetic storage medium such as a hard disk, an optical storage medium such as a compact disc (CD), and a storage medium utilizing both of the magnetic storage and the optical storage. In the description below, a hard disk is utilized as the storage medium 11. A NAND flash memory can be utilized as the nonvolatile memory 10a. A keypad, a touch screen, a scroll button, or a remote controller can be utilized as the input unit 13. A liquid crystal display, a light emitting diode (LED) panel, or an electro-luminescence (EL) panel can be utilized as the display 16.

The music file that conforms to an audio format such as the moving picture expert group audio layer 3 (MP3) is stored in the storage medium 11 and in the nonvolatile memory 10a. The nonvolatile memory 10a is designed to have an arbitrary storage capacity of 64 megabytes, 128 megabytes, 256 megabytes, or the like.

The processor 140a, the I/F 142, the controller 143a, the nonvolatile memory controller 145, the D/A converter 146, the USB I/F 147, a read only memory (ROM) (not illustrated), and a random access memory (RAM) (not illustrated) are connected to the bus line 141. The controller 143a is connected to the driving mechanism 12. The nonvolatile memory controller 145 is connected to the nonvolatile memory 10a. The USB I/F 147 is connected to a personal computer (PC) via a USB cable (not illustrated), for instance. The D/A converter 146 is connected to an audio output device such as an earphone or a speaker. The ROM stores a program (a firmware) to be executed by the processor 140a, and stores various data. The RAM is utilized as a work area when the processor 140a executes the program, and stores the program (firmware).

The controller 143a controls a writing operation and a reading operation to and from the storage medium 11 by controlling the driving mechanism 12 to be turned on and off. The nonvolatile memory controller 145 controls a writing operation and a reading operation to and from the nonvolatile memory 10a. The processor 140a controls operations of the interface (I/F) 142, the controller 143a, the nonvolatile memory controller 145, the D/A converter 146, and the USB I/F 147, and the like.

When storing music files, music files are transferred from the PC to the USB I/F 147 via the USB cable and are stored in the storage medium 11. On the contrary, when playing the music files, the processor 140a controls the controller 143a and the nonvolatile memory controller 145 to transfer the music files one by one from the storage medium 11 and to store the music files in the nonvolatile memory 10a. The music files stored in the nonvolatile memory 10a are sequentially supplied to the processor 140a and subjected to playback processes, i.e. decoding, and the like. Specifically, instead of turning the driving mechanism 12 on all the time, the power is turned off once the data is transferred to the nonvolatile memory 10a, and the music file in the nonvolatile memory 10a will be played thereafter.

Accordingly, the driving mechanism 12 is operated just for reading the data out corresponding to a single music piece, and is stopped until there is a demand for the data corresponding to the next music piece. In this way, reduction in power consumption is achieved. Moreover, since the nonvolatile memory 10a is used as a buffer memory for the storage medium 11, it is unnecessary to operate the driving mechanism 12 in the power-on state (at the time of restarting playback). Accordingly, it is possible not only to achieve reduction in power consumption, but also to shorten a time interval from turning the power on to starting playback.

Alternatively, the processor 140a stores the music files corresponding to multiple music pieces in the nonvolatile memory 10a within the storage capacity of the nonvolatile memory 10a based on playback order information indicating the order of playing the music files. After storing the music files corresponding to the multiple music pieces in the nonvolatile memory 10a, it is possible to substantially eliminate operations of the driving mechanism 12 except for updating the data in the storage medium 11 and for selecting or changing the playback order of the music pieces by a user.

Here, a play list including the playback order that is arbitrarily designated by the user can be used as the playback order information, for example. The play list is stored in the storage medium 11 as a file, as in the case of the music files. When there is no play list, the order of the music pieces (the music files) stored in the storage medium 11 may be directly used as the playback order.

The storage medium 11 also stores directory information indicating configurations of the stored music files. Specifically, it is possible to perform selection depending not only on the music pieces but also on folders sorted by categories, singers, albums, and the like. Selection of a certain folder is equivalent to selection of all music pieces in subfolders in that folder. Here, the display device 16 can display a directory structure of the music files. Therefore, the user can easily select the file that the user wishes to play out of the numerous music files.

A playback operation of the music player 1a according to the first embodiment will be described by referring to a flowchart shown in FIG. 2. It is to be noted, however, that the following explanation is based on the case of starting the music player 1a from the initial state (the reset state), and of storing the music files corresponding to multiple music pieces in the nonvolatile memory 10a.

After turning the music player 1a on, music pieces subjected to playback (playback files) are determined by a user's operation with an input unit 13 in step S11.

In step S12, the processor 140a instructs the controller 143a to turn the driving mechanism 12 on. As a consequence, the driving mechanism 12 reads the music files out of the storage medium 11.

In step S13, the processor 140a instructs the nonvolatile memory controller 145 to store the music files that were read out of the storage medium 11, into the nonvolatile memory 10a. The music files stored in the nonvolatile memory 10a are transferred to the processor 140a and subjected to the playback processes.

In step S14, the nonvolatile memory controller 145 judges whether an empty space runs out in the nonvolatile memory 10a for storing the music files. The procedure goes to step S15 when a judgment that the empty space runs out in the nonvolatile memory 10a is made. The procedure goes to step S17 when a judgment that there still remains the empty space in the nonvolatile memory 10a is made.

In step S15, the processor 140a instructs the controller 143a to turn the driving mechanism 12 off and to stop operating the driving mechanism 12. After stropping the operation of the driving mechanism 12, only the playback processes are performed by use of the music files stored in the nonvolatile memory 10a.

In step S16, the nonvolatile memory controller 145 judges whether the empty space in the nonvolatile memory 10a for storing the music files is equal to or more than a predetermined capacity as a result of the playback processes, e.g. whether or not the empty space is equal to or more than approximately two-thirds of the entire storage capacity of the nonvolatile memory 10a. The procedure returns to step S12 when the empty space is judged to be equal to or more than the predetermined capacity.

In step S17, the processor 140a judges whether or not there is continuous playback of the music files, i.e. whether or not there is a music file to be played after the currently played music file. The procedure goes to step S18 when a judgment is made that there is no continuous playback of the music files, and the driving mechanism 12 is turned off.

As described above, according to the first embodiment, the nonvolatile memory 10a is utilized as the buffer memory for the storage medium 11. Accordingly, even when the playback of the music file is interrupted and the power is turned off, it is possible to read the music file out of the nonvolatile memory 10a and to restart the playback without reading the data out of the storage medium 11 after a restarting operation. Therefore, it is possible to reduce the number of operations of the driving mechanism 12 and thereby to reduce power consumption of the music player 1a as a whole. Moreover, in the case of restart after the interruption of the playback of the music file, the playback of the data in the nonvolatile memory 10a is restarted without waiting for readout of the music file again from the storage media 11. Accordingly, it is possible to shorten a time period required for restarting the playback.

First Modification of First Embodiment

The processor 140a shown in FIG. 1 may execute a vibration-resistant operation in accordance with user's input operation with the input unit 13, as a first modification of the first embodiment. In the vibration-resistant operation, the processor 140a only plays music files stored in the nonvolatile memory 145 without operating the driving mechanism 12.

The music player 1a may detect vibration or shock, and automatically execute the vibration-resistant operation by use of a sensor such as an acceleration sensor. In this case, even when it is determined that the empty space in the nonvolatile memory 10a for storing the music files is equal to or more than the predetermined capacity in step 16 of FIG. 2, reading out from the storage medium 11 is canceled until vibration or shock is stopped. However, it is possible for the user to continuously listen music because music files stored in the nonvolatile memory 145 are played.

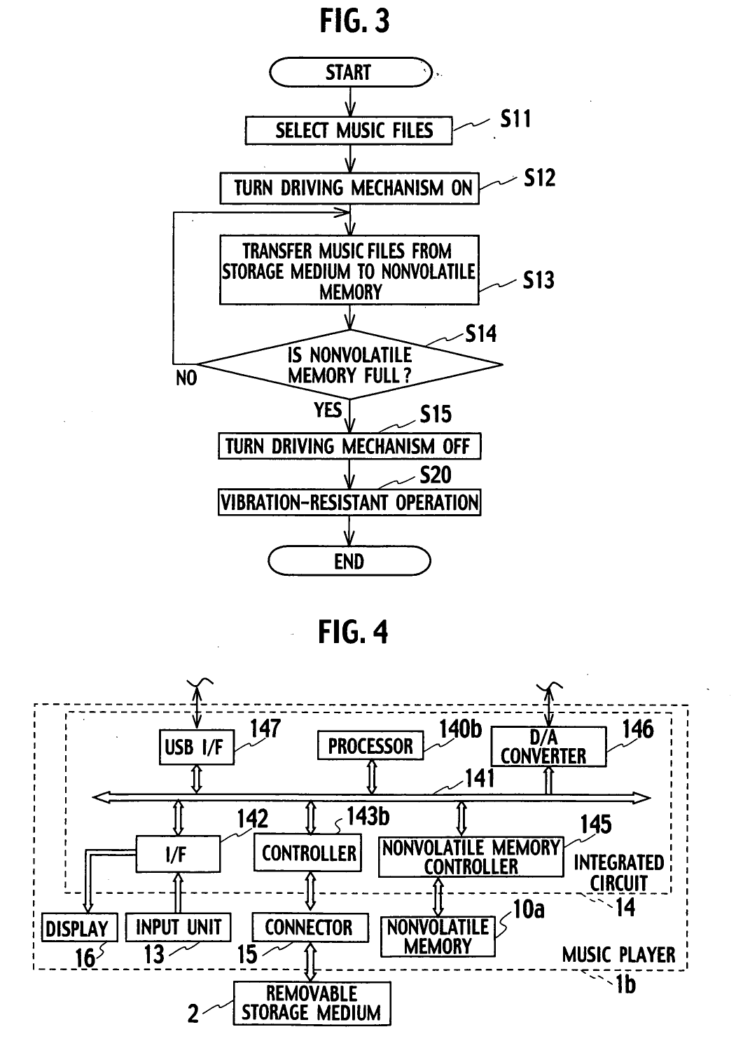

As shown in FIG. 3, music files stored in the nonvolatile memory 145 in steps S1 to S15 are played in step S20 when the vibration-resistant operation is executed in accordance with user's input operation. According to the first modification of the first embodiment, it is possible to prevent the driving mechanism 12 from breaking down because the driving mechanism 12 does not operate under environment causing vibration or shock.

Second Modification of First Embodiment

As shown in FIG. 4, a music player 1b according to a second modification of the first embodiment of the present invention may include a connector 15 configured to connect a removable storage medium 2 instead of the storage medium 11 shown in FIG. 1.

The shape of the removable storage medium 2 conforms to personal computer memory card international association (PCMCIA) standard, for instance. It is possible to use by directly inserting in a PC because the removable storage medium 2 includes a driving mechanism in addition to a storage medium.

### Second Embodiment

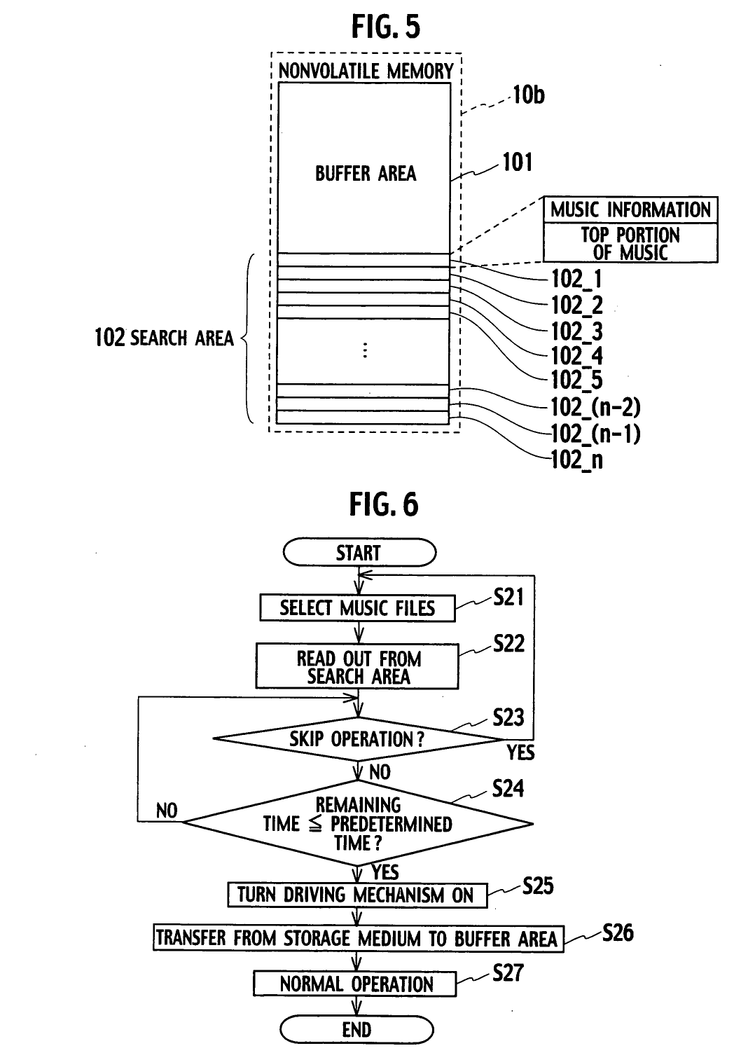

As shown in FIG. 5, a music player according to a second embodiment of the present invention differs from the first embodiment in that a nonvolatile memory 10b includes a search area 102 utilized for searching music files, in addition to a buffer area 101 configured to store a plurality of music files. The processor 140a shown in FIG. 1 causes the search area 102 to store each top portion of music files. In the example of FIG. 5, the search area 102 is divided into a plurality of storage area 102_1 to 102_n (“n” is integer more than or equal to two). Other arrangements are similar to the music player 1a shown in FIG. 1.

In the first embodiment, music files are transferred from the storage medium 11 to the nonvolatile memory 10a for each search operation. Or, many music files within the capacity of the nonvolatile memory 10a are stored, in accordance with the playback order. The driving mechanism 12 operates at all the time when a user searches a desired music file, by listening top portions of each music file.

The buffer area 101 of the nonvolatile memory 10b stores music files for playback. The search area 102 stores each top portion (five second, for instance) of music files before and after playback order against currently playing music. A music file of five second has about 40 K bytes by use of MP3 format. Therefore, it is possible to store each top portion of 400 music files when the storage capacity of the search area 102 is about 16 M bytes.

As a result, it is possible to reduce unnecessary operation of the driving mechanism 12. The management of music files becomes easy by storing music files together with music information such as the music title, the music length, and the musician.

It is necessary to analyze data in the storage medium 11 so as to store the searching data (top portions) to the search area 102. After transferring music files from a PC, the driving mechanism 12 operates so as to generate table when the USB cable is removed out of the USB I/F 147. The generation of the table requires long time because of the processing ability of the processor 140a, and increase the power consumption.

In transferring data to the storage medium 11 by connecting to a PC via USB I/F 147, the PC transfers the search data to the search area 102 of the nonvolatile memory 10b. When the search area 102 has no storage capacity enough to store search data of all music files, the search area 102 may store data possible in the order of the play list. When the number of play-lists is one or play-lists having a priority, the entire music file possible may be stored in the buffer area 101. As a result, it is possible to reduce the number of accesses for the storage medium 11.

A playback operation of the music player according to the second embodiment will be described by referring to a flowchart shown in FIG. 6. Repeated descriptions for the same operation according to the second embodiment which are the same as the first embodiment are omitted. It is assumed that each top portion of music files is previously stored in the search area 102.

After turning the music player on, music pieces subjected to playback (playback files) are determined by a user's operation with an input unit 13 shown in FIG. 1 in step S21.

In step S22, the processor 140a instructs the nonvolatile memory controller 145 to read a music file (top portion) out from the search area 102 shown in FIG. 5. The processor 140a plays the music file (top portion) transferred from the search area 102.

In step S23, the processor determines whether a skip operation, i.e., a forward search operation or a backward search operation is required by a user's input operation with the input unit 13. When it is determined that the skip operation is required, the procedure returns to step S21. When it is determined that the skip operation is not required, the procedure goes to step S24.

In step S24, the nonvolatile memory controller 145 determines whether the remaining time of the playing music file (top portion) becomes less than or equal to a predetermined time. When each storage area 102_1 to 102_n of the search area 102 stores music file of five seconds, the nonvolatile memory controller 145 determines whether the remaining time of the playing music file (top portion) becomes less than or equal to two seconds. When it is determined that the remaining time becomes less than or equal to the predetermined time, the procedure goes to step S25. When it is determined that the remaining time does not become less than or equal to the predetermined time, the procedure returns to step S23.

In step S25, the processor 140a instructs the controller 143a to turn the driving mechanism 12 on. As a result, the driving mechanism 12 reads out the music file. Here, the music file read out of the storage medium 11 is the same music file which is determined that the remaining time is less than or equal to the predetermined time in step S24, and is a music file except for the top portion. The music file read out from the storage medium 11 is stored in the buffer area 101 shown in FIG. 5.

In the step S27, a normal operation utilizing the buffer area 101, i.e., operation similar to after step S14 is executed.

As described above, according to the second embodiment, it is possible to play music files stored in the search area 102 when the user selects desired music, and to operate the driving mechanism 12 only when playing time of the music stored in the search area is more than or equal to a predetermined time. Furthermore, by utilizing the buffer area 101 as a buffer memory of the storage medium 11, it becomes possible to restart playback of music by use of the buffer area 101 without operating the storage medium 11 in restarting playback even when the power becomes a off state in playing the music file. It is possible to decrease time for restarting playback because music files previously stored in the search area 102 when a user selects music.

### Other Embodiments

Various modifications will become possible for those skilled in the art after receiving the teachings of the present disclosure without departing from the scope thereof.

In the aforementioned embodiments, the description has been given with regard to an example in which the processor 140a shown in FIG. 1 causes the nonvolatile memory to store each top portion of music files. However, the processor 140a may cause the nonvolatile memory 10a to store music files that were recently played. By storing music files that were recently played, it becomes possible to play music files that are usually played without operating the driving mechanism.

In the aforementioned embodiments, the description has been given with regard to an example in which a NAND flash memory is utilized as the nonvolatile memories 10a and 10b. However, other memories such as a ferroelectric random access memory (FeRAM) or a magnetoresistive random access memory (MRAM) can be utilized as the nonvolatile memories 10a and 10b.

Since the storage medium 11 can be used as a normal storage medium, it is possible to store other application data such as a text file or a picture file.

A part of the nonvolatile memories 10a and 10b can be utilized as a work area and a program storage area of the processors 140a and 140b. As a result, it is possible to remove the RAM and ROM.

What is claimed is:

1. A music player comprising:
a driving mechanism configured to rotate a storage medium, and to read a music file out of the storage medium;
a nonvolatile memory configured to store the music file transferred from the storage medium; and
a processor configured to read out the music file out of the nonvolatile memory, and to play the music file.

2. The music player of claim 1, wherein the processor reads the music file out of the nonvolatile memory without operating the driving mechanism when power is turned on.

3. The music player of claim 1, wherein the processor causes the nonvolatile memory to store a plurality of music files corresponding to multiple music pieces in order of playback starting from initiation of the playback.

4. The music player of claim 1, wherein a play list including the playback order that is arbitrarily designated by a user is utilized as the order of playback.

5. The music player of claim 1, wherein the nonvolatile memory includes a search area for searching the music file, and the search area stores each top portion of a plurality of music files in the storage medium.

6. The music player of claim 5, wherein the search area further stores music information including one of music titles, music length, and musicians.

7. The music player of claim 5, wherein the top portion of the music files is stored in the search area when the music file is transferred from an external host machine to the storage medium.

8. The music player of claim 7, wherein the top portion of the music files is stored in the order of the playback within a storage capacity of the nonvolatile memory.

9. The music player of claim 1, wherein the processor reads the music file out of the nonvolatile memory without operating the driving mechanism when a vibration-resistant operation.

10. The music player of claim 1, wherein a part of the nonvolatile memory is utilized as a work area and a program storage area for the processor.

11. The music player of claim 1, wherein the processor causes the nonvolatile memory to store music files that were recently played.

12. A music player configured to play a music file read out of a removable storage medium, having a storage medium and a driving mechanism configured to rotate the storage medium, comprising:
a connector configured to connect the removable storage medium:
a nonvolatile memory configured to store the music file read out of the storage medium; and
a processor configured to read the music file out of the nonvolatile memory, and to play the music file.

13. The music player of claim 12, wherein the processor reads the music file out of the nonvolatile memory without operating the driving mechanism when power is turned on.

14. The music player of claim 12, wherein the processor causes the nonvolatile memory to store a plurality of music files corresponding to multiple music pieces in order of playback starting from initiation of the playback.

15. The music player of claim 12, wherein a play list including the playback order that is arbitrarily designated by a user is utilized as the order of playback.

16. The music player of claim 12, wherein the nonvolatile memory includes a search area for searching the music file, and the search area stores each top portion of a plurality of music files in the storage medium.

17. The music player of claim 16, wherein the search area further stores music information including one of music titles, music length, and musicians.

18. The music player of claim 16, wherein the top portion of the music files is stored in the search area when the music file is transferred from a host machine to the storage medium.

19. The music player of claim 18, wherein the top portion of the music files is stored in the order of the playback within a storage capacity of the nonvolatile memory.

20. The music player of claim 12, wherein the processor reads the music file out of the nonvolatile memory without operating the driving mechanism when a vibration-resistant operation.

21. The music player of claim 12, wherein a part of the nonvolatile memory is utilized as a work area and a program storage area for the processor.

22. The music player of claim 12, wherein the processor causes the nonvolatile memory to store music files that were recently played.
